(19) United States
(12) Patent Application Publication
(10) Pub. No.: US 2018/0152316 A1
(43) Pub. Date: May 31, 2018

(54) Method and Apparatus for Operating a Sensor System, Sensor System

(71) Applicant: Robert Bosch GmbH, Stuttgart (DE)

(72) Inventors: Daniel Schoenfeld, Abstatt (DE); Marlon Ramon Ewert, Untergruppenbach (DE)

(21) Appl. No.: 15/824,348

(22) Filed: Nov. 28, 2017

(30) Foreign Application Priority Data
Nov. 29, 2016 (DE) 10 2016 223 673.3

(51) Int. Cl. H04L 12/40; G06F 13/16; G06F 13/42; G06F 13/40; B60R 21/0136

(52) U.S. Cl. CPC H04L 12/4013; G06F 13/1678; B60R 2021/01013; G06F 13/4068; B60R 21/0136; G06F 13/4282

(57) ABSTRACT

A method for operating a sensor system for operating a sensor system includes electrically connecting sensors of a plurality of sensors to one another with a bus system. The method further includes communicating with the plurality of sensors over the bus system using a control device. The method further includes controlling one or more of the sensors of the plurality of sensors to transmit data to the control device with a predefinable bit width. The method further includes controlling one or more of the sensors of the plurality of sensors to transmit data to the control device with a reduced bit width. The sensor system includes the plurality of sensors and the control device.

This application claims priority under 35 U.S.C. § 119 to patent application no. DE 10 2016 223 673.3 filed on Nov. 29, 2016 in Germany, the disclosure of which is incorporated herein by reference in its entirety.

The disclosure relates to a method for operating a sensor system for a motor vehicle, the sensor system having a plurality of sensors, which are electrically connected to one another by means of a bus system, and a control device which electrically communicates with the sensors by means of the bus system, the sensors being controlled to transmit data to the control device with a predefinable bit width.

The disclosure also relates to an apparatus for operating such a sensor system and to a corresponding sensor system having such an apparatus.

### BACKGROUND

In order to increase the safety of occupants of motor vehicles and other road users, it is known practice to provide safety devices on/in the motor vehicle, which safety devices protect the occupants and/or other road users, for example pedestrians, from serious injuries, in particular in the event of an accident. Airbag devices, seatbelt tensioners or other restraint means, for example, are known as such safety devices. These safety devices are controlled on the basis of sensor data from a sensor system which detects a collision with a further road user, for example. Sensor systems which have two or more acceleration sensors and/or comprise a system based on a pressure hose, for example, are known for the purpose of detecting accidents involving pedestrians. These systems are then arranged in a bumper of the vehicle, for example, in order to detect the collision of the vehicle with an object from the environment in the direction of travel in the forward direction of travel or the reverse direction of travel. Sensor systems which have, in particular, at least one acceleration sensor on the B-pillar, C-pillar or D-pillar of the motor vehicle or have, in particular, at least one pressure sensor in the vehicle door are nowadays used to detect collisions on a vehicle longitudinal side. It is also known practice to arrange acceleration sensors in the central control device or along a flexible crossmember of the motor vehicle. The signals output by the sensors are processed further by means of algorithms of a control device, in particular an airbag control device, in order to make a decision on the triggering of the respective safety device.

Modern communication protocols, for example the PSI5 protocol, make it possible to jointly connect a plurality of sensors to a data bus which also allows direct optional communication for the purpose of sensor configuration/control and diagnosis. It is known practice, for example, to evaluate data from pressure or acceleration sensors in airbag systems using current-modulated two-wire buses which communicate with the control device via a Manchester-coded protocol. Different operating modes are known in this case, such as the synchronous mode or the asynchronous mode. In the synchronous operating mode, the three operating modes of parallel bus mode (all sensors are connected in parallel), universal bus mode (serial connection of the sensors) and daisy-chain bus mode result depending on the configuration of the sensors and the control device. Combined with other parameters, such as the total number of time windows, data rate, data word length, parity/CRC monitoring, PSI5 communication allows different possible implementations. It is widespread that the sensors transmit data to the control device via the bus with a bit width of 10 bits. The advantage of this is that the sensors can be arranged on a conduction band and are therefore already preassembled on the data line, which considerably reduces the assembly complexity in the motor vehicle and also facilitates the connection to the control device. It is therefore known practice to connect the conductor band to the control device or to a further connecting line by means of a plug-in connection at the end of the conduction band.

### SUMMARY

The method according to the disclosure has the advantage that a greater number of sensors than before can be arranged on the conduction band and can be electrically contacted. This is achieved by reducing the bit width of the transmitted data in comparison with previous solutions. The data bus is therefore used less and provides space for the data from further sensors. The disclosure provides for the sensors to be controlled to transmit the data with a reduced bit width, in particular of 5 bits or less.

In addition to the data, communication information, such as a start bit and an end bit or a parity bit, is also usually concomitantly transmitted. Solely reducing the data bits or the bit width of the data reduces the bit width of transmitted bits in a data packet in such a manner that the communication channel or communication bus releases space for transmitting further data information from other sensors. The data width of 5 bits is one possible embodiment in this case. Depending on the use and number of sensors, the bit width can also be reduced even further, for example to 3 bits per sensor. In principle, the disclosure provides for the bit width of the transmitted data from at least one of the sensors, preferably from all of the sensors, to be reduced with increasing number of sensors connected to the one conduction band. The sensors are preferably arranged on a conduction band which is/can be connected to the control device by means of a plug-in connection, for example.

One preferred development of the disclosure provides for at least one of the sensors to be controlled to transmit the data with a reduced resolution in order to reduce the bit width. The reduced resolution of the data is compensated for by the increased number of sensors, with the result that the functionality of the sensor system is not impaired by reducing the data width. For example, the bit width of the data is halved.

Alternatively or additionally, provision is preferably made for at least one of the sensors to be controlled to preprocess the data before it transmits the data to the control device in order to reduce the bit width. The preprocessing maintains the information content of the data with simultaneous compression of the volume of data. This means that data representing the data signal, rather than the raw signal from the sensors, are transmitted to the communication bus with a reduced bit width.

In particular, provision is made for the captured data from the at least one sensor to be compared with at least one threshold value by the sensors themselves. Only data which exceed the predefined threshold value are therefore transmitted, for example.

The captured data are preferably filtered, integrated and/or derived before they are transmitted to the control device. This also reduces the volume of data while retaining the essential information to be transmitted.

Provision is particularly preferably made for at least one of the sensors to be controlled to compare the data with a plurality of threshold values, a bit value to be transmitted being increased with the number of exceeded thresholds. Increasing the bit value with the number of exceeded thresholds makes it possible to easily restrict the information content to the essential items, namely the level of the bit value or of the output signal from the respective sensor, and to communicate it to the control device without having to transmit the complete data. As a result, the data are advantageously preprocessed in order to reduce the bit width.

Provision is preferably also made for the control device to communicate with the sensors by means of a PSI5 protocol. This is a known standard which allows simple implementation of the method described, with the result that the advantageous method can also be integrated in existing sensor systems without a large amount of additional effort or additional costs.

Provision is also preferably made for the described reduction in the resolution and the preprocessing of the sensor data to be carried out alternately in order to enable the optimum information content for the control device with optimum use of the bus system. Alternatively, provision is preferably made for at least one of the sensors to reduce the resolution and for at least another of the sensors on the conduction band to preprocess the data as described. Depending on the requirement imposed on the respective sensor for example, one of the advantageous methods mentioned can therefore be used to reduce the bit width. One preferred development of the disclosure also provides for the extent of the reduction, that is to say the actual bit width, rather than the type of reduction, to be additionally or alternatively alternately varied, in particular. In addition, the data in a plurality of sensors are likewise preferably transmitted alternately to the same reduced bits using the same communication time slot, with the result that 5 bits, for example, can be used for a plurality of sensors.

The apparatus according to the disclosure is distinguished by the fact that the sensors are specifically set up to carry out the method according to the disclosure when used as intended. The advantages already mentioned result from this.

The sensor system according to the disclosure is distinguished by the apparatus according to the disclosure. The advantages already mentioned also result from this. In this case, the sensors of the sensor system are preferably in the form of pressure sensors, acceleration sensors, rate-of-rotation sensors or a combination thereof.

Further advantages and preferred features and combinations of features result, in particular, from the description above and from the claims.

### BRIEF DESCRIPTION OF THE DRAWINGS

The disclosure shall be explained in more detail below on the basis of the drawing.

FIG. 1 shows a simplified illustration of an advantageous sensor system.

### DETAILED DESCRIPTION

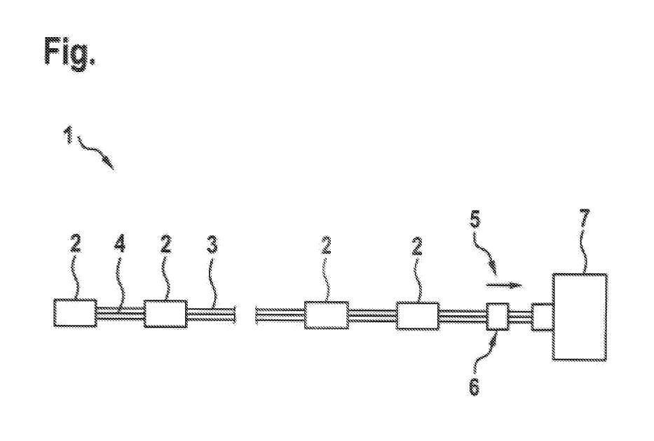

FIG. 1 shows a simplified illustration of an advantageous sensor system 1. The sensor system 1 has a plurality of sensors 2 which are in the form of pressure sensors, acceleration sensors or rate-of-rotation sensors, for example. The sensors 2 are arranged on a conduction band 3 which is used to make electrical contact with all sensors 2 for the purpose of supplying energy, on the one hand, and transmitting signals, on the other hand. For this purpose, provision is made in the present case for the conduction band 3 to make contact with or operate the sensors 2 by means of a bus system 4 which is shown in FIG. 1 by means of a simplified connecting line. At a free end 5 of the conduction band, the latter has a contact apparatus 6, preferably in the form of a plug contact, which is or can be used to connect the sensor system 1 to a control device 7 indicated here. The control device 7 receives data signals from the sensors 2 by means of the bus system 4 and evaluates said signals. In the present case, communication takes place by means of the PSI5 protocol in which data captured by the sensors are transmitted to the control device 7 by means of bit-coded data packets. In this case, a data packet advantageously comprises two start bits, a predetermined number of data bits which describe the actual bit value to be transmitted, and an end bit or parity bit.

In contrast to previously known solutions, the sensors 2 are controlled, in particular by the control device 7, to transmit the data packets with a reduced bit width. The bit width of the data transmission results from the number of bits in the respective data packet. For this purpose, provision is made in the present case for the data to be transmitted using 1 to 10 bits, in particular using 5 bits or 3 bits. As usual, the data then also include 1 to 2 start bits and the parity bit, thus resulting in a total bit width of 4 bits to 13 bits.

The number of bits is advantageously reduced by means of at least one of the two methods described below:

A first exemplary embodiment provides for the output signals from the sensors 2 to be passed to the communication bus or the bus system 4 with a diminished resolution, the bit width being reduced for each sensor 2. An example of such a reduction in the bit width is, for example, the halving of the bits for each sensor on the PSI5 communication bus. As a result, the communication bus or the bus system 4 is used less by the sensors 2, with the result that additional sensors 2 can be added to the communication bus 4. Increasing the number of sensors maintains the measurement accuracy of the sensor system 1 despite a reduced bit width, in which case the advantage of more sensor values overall and therefore a particularly high monitoring width being achieved by the sensors 2 is achieved on account of the increased number of sensors.

A second exemplary embodiment provides for the bit width to be reduced by virtue of the sensors 2 already preprocessing the data signals output to the communication bus by the sensors 2. This reduces the bit width of the transmission to 3 bits per sensor, in particular. Preprocessed sensor signals, for example, are transmitted in these 3 bits. For example, the pressure or acceleration rates of one of the sensors 2 can already be compared in the sensor with predetermined threshold values corresponding to a signal strength, for example. In particular, provision is made for the captured data signals from the respective sensor to be compared with a plurality of threshold values which correspond to different signal strengths. For this purpose, the captured data signals are advantageously filtered, integrated or derived in the respective sensor 2. The more threshold values are exceeded by the preprocessed signal from the sensor, the higher the incrementation of the bit value defined by the 3 bits. If, for example, none of the threshold values is exceeded, 000 is determined as the bit value. If a first threshold value is exceeded, 001 is determined as the bit value. If a second threshold value which is higher than the first threshold value is exceeded, 010 is determined as the bit value. If a third threshold value which is higher than the second threshold value is exceeded, 100 is output as the bit value.

It goes without saying that further information and further features of the respective sensor 2 can also be represented in the 3 bits. In the present case, the 3 bits can be understood as an example and may vary depending on requirements.

Another exemplary embodiment provides for a combination of the two methods described above to be carried out by the sensor system 1. In particular, provision is made for a pair of the sensors 2 to place their data on the communication bus with a lower resolution and for the remaining sensors to preprocess the captured data as described in order to reduce the number of bits. Another exemplary embodiment provides for the sensors 2 of the sensor system 1 to transmit their data to the communication bus in a manner alternating between the two methods described, with the result that the respective sensor 2 outputs the data once with a lower resolution and transmits preprocessed data to the communication bus in the next data set.

The advantage of the described method is that more sensors than before can be arranged on the conduction band 3 and can be used by the bus system 4. The interfaces and the cabling complexity are considerably reduced as a result, in particular for applications in which a large number of sensors is required. Despite the reduced number of bits, the sensors 2 provide a residual performance which allows the control device 7 to comprehend the basic signal profile of the respective output signal. Even if the information is no longer as accurate as before, this disadvantage is more than just compensated for by the increased number of sensors. Therefore, the sensor system 1 advantageously has more than three, in particular more than four, sensors, which is not possible with previous operating methods on account of the use of the communication bus 4.

What is claimed is:

1. A method for operating a sensor system for a motor vehicle, the sensor system having a plurality of sensors and a control device, the method comprising:
electrically connecting sensors of the plurality of sensors to one another with a bus system;
communicating with the plurality of sensors over the bus system using the control device;
controlling one or more of the sensors of the plurality of sensors to transmit data to the control device with a predefinable bit width; and
controlling one or more of the sensors of the plurality of sensors to transmit data to the control device with a reduced bit width.

2. The method as claimed in claim 1, further comprising:
controlling a respective sensor of the plurality of sensors to transmit the data with a bit width of 5 bits or less.

3. The method as claimed in claim 1, further comprising:
controlling at least one sensor of the plurality of sensors to transmit the data with a reduced resolution in order to reduce the bit width.

4. The method as claimed in claim 1, further comprising:
controlling at least one sensor of the plurality of sensors to preprocess the data before the data are transmitted to the control device in order to reduce the bit width.

5. The method as claimed in claim 1, further comprising:
controlling at least one sensor of the plurality of sensors to compare captured data with at least one threshold value.

6. The method as claimed in claim 1, further comprising:
controlling at least one sensor of the plurality of sensors to filter, integrate, and/or derive the data before transmitting the data to the control device.

7. The method as claimed in claim 1, further comprising:
controlling at least one sensor of the plurality of sensors to compare data with a plurality of threshold values; and
increasing a bit value to be transmitted based on a number of exceeded threshold values.

8. The method as claimed in claim 1, wherein the control device communicates with the sensors of the plurality of sensors using a PSI5 protocol.

9. The method as claimed in claim 1, further comprising:
controlling at least one sensor of the plurality of sensors to alternately transmit the data with the reduced resolution and to preprocess the data in order to reduce the bit width before transmitting the data to the control device.

10. The method as claimed in claim 1, further comprising:
controlling at least one sensor of the plurality of sensors to alternately vary the bit width.

11. The method as claimed in claim 1, wherein the control device is configured to control one or more of the sensors of the plurality of sensors to (i) transmit data to the control device with the predefinable bit width, and (ii) to transmit data to the control device with a reduced bit width.

12. A sensor system for a motor vehicle comprising:
a conduction band;
a plurality of sensors arranged on the conduction band and configured to make electrical contact with the conduction band,
a bus system configured to connect electrically sensors of the plurality of sensors; and
a control device connected to the conduction band configured to communicate with the sensors of the plurality of sensors using the bus system, the control device configured to operate the plurality of sensors by
controlling one or more of the sensors of the plurality of sensors to transmit data to the control device with a predefinable bit width, and
controlling one or more of the sensors of the plurality of sensors to transmit data to the control device with a reduced bit width.

13. The sensor system as claimed in claim 1, further comprising:
a contact apparatus configured to connect the plurality of sensors to the control device.

14. The method as claimed in claim 1, wherein the plurality of sensors are arranged on a conduction band.

15. The method as claimed in claim 1, wherein all of the plurality of sensors are configured to transmit the data with a reduced bit width.

16. The method as claimed in claim 10, wherein at least one of the sensors is configured to alternately vary the bit width.
